(19) United States
(12) Patent Application Publication
(10) Pub. No.: US 2023/0081058 A1
(43) Pub. Date: Mar. 16, 2023

(54) Enhanced Downlink Link Adaptation (DLLA) for Spectral Efficiency Maximization

(71) Applicant: Parallel Wireless, Inc., Nashua, NH (US)

(72) Inventors: Nimrod Gradus, Givatayim (IL); Ido Shaked, Alfei Menashe (IL); Benjamin Abramovsky, Petah Tiqwa (IL)

(21) Appl. No.: 17/823,078

(22) Filed: Aug. 29, 2022

Related U.S. Application Data
(60) Provisional application No. 63/237,603, filed on Aug. 27, 2021.

(51) Int. Cl. H04L 1/00; H04L 1/18

(52) U.S. Cl. CPC H04L 1/0003; H04L 1/1896

(57) ABSTRACT

A method is disclosed for enhancing downlink link adaptation (DLLA) for spectral efficiency maximization, comprising: providing an outer loop link adaptation (OLLA) routine with a first path for a first transmission mode and a second path for a second transmission mode; modifying, upon receiving a retransmit message for a first transmission with the first transmission mode, a first offset coefficient; modifying, upon receiving a second retransmit message for a second transmission with the second transmission mode, a second offset coefficient; and calculating a modulation and coding scheme (MCS) offset for the first transmission based on the first offset coefficient.

### CROSS-REFERENCE TO RELATED APPLICATIONS

This application claims priority under 35 U.S.C. § 119(e) to U.S. Provisional Pat. App. No. 63/237,603, entitled “Enhanced Downlink Link Adaptation (DLLA) for Spectral Efficiency Maximization,” and filed Aug. 27, 2021, which is hereby incorporated by reference in its entirety. This application hereby incorporates by reference, for all purposes, each of the following U.S. patent application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

The downlink link adaptation (DLLA) process is a crucial part in the eNB for allowing an efficient and reliable data transfer. Traditionally, the DLLA comprises of two mechanism, outer loop link adaptation (OLLA) and inner loop link adaptation (ILLA).

The outer loop link adaptation is responsible for the calculation of the UE's MCS offset according to the HARQ, ACK, NACK feedback, so that the average BLER is kept as close as possible to a predefined target BLER.

Inner loop link adaption applies the OLLA's offset on the estimated MCS received from the UE's CQI reports and determines the MCS to be used for the DL transmission without taking into consideration the DL MIMO transmission mode (TM), e.g., transmit diversity (TD) or spatial multiplexing (SM).

TD and SM are two different MIMO TMs, while in TD the same data is transmitted redundantly over more than one transmits antenna and by that increasing the signal-to-noise ratio (SNR), SM is used for the division of data into separate streams, which are transmitted simultaneously over the same air interface resources and therefore increasing the data rate. The choice of using each TM is considered using the UE's rank indicator (RI) report.

### SUMMARY

A method is disclosed for enhancing downlink link adaptation (DLLA) for spectral efficiency maximization, comprising: providing an outer loop link adaptation (OLLA) routine with a first path for a first transmission mode and a second path for a second transmission mode; modifying, upon receiving a retransmit message for a first transmission with the first transmission mode, a first offset coefficient; modifying, upon receiving a second retransmit message for a second transmission with the second transmission mode, a second offset coefficient; and calculating a modulation and coding scheme (MCS) offset for the first transmission based on the first offset coefficient.

The retransmit message may be an HARQ ACK/NACK and the first transmission mode may be a transmit diversity (TD) transmission mode and the first offset coefficient may be an offsetTD. The second retransmit message may be an HARQ ACK/NACK and the second transmission mode may be a spatial multiplexing (SM) transmission mode and the second offset coefficient may be an offsetSM. The method may further comprise calculating a modulation and coding scheme (MCS) offset based on an ACK/NACK and a number of code words that were sent. The OLLA routine may be for a 4G LTE radio access technology or a 5G radio access technology. A transmission mode may be reported by a user equipment (UE).

The method may further comprise providing the MCS offset to an inner loop link adaptation (ILLA) routine. The method may further comprise calculating a second modulation and coding scheme (MCS) offset for the second transmission based on the second offset coefficient. The method may further comprise reporting a preferred transmission mode to a scheduler. The method may further comprise subtracting a specific stepdown quantity from the MCS offset if a NACK may be received. The method may further comprise adding a specific stepup quantity from the MCS offset if an ACK may be received.

### BRIEF DESCRIPTION OF THE DRAWINGS

FIG. 1 is a schematic diagram of a base station scheduler, in accordance with some embodiments.

FIG. 2 is a flowchart, in accordance with some embodiments.

FIG. 3 is a schematic diagram of a telecommunications network, in accordance with some embodiments.

FIG. 4 is a schematic diagram of an enhanced eNodeB, in accordance with some embodiments.

### DETAILED DESCRIPTION

Downlink link adaptation (DLLA) is a core feature in the downlink access stratum in the eNB. Through the channel quality indicator (CQI), the DLLA suggests the scheduler an appropriate modulation and coding scheme (MCS) for the downlink transmission according to the UE's channel conditions. In order to overcome errors and deviations in the process, the outer loop link adaptation (OLLA) algorithm is used to adaptively modify and calculate offsets from the reported CQI, according to whether the data packets were received correctly or not, for the purpose of adjusting the block error rate (BLER) to a target. In this invention, we modify the OLLA operation by feeding it information about transmission mode, for example whether the ack/nack reports were due to a transmission of transmit diversity (TD) or spatial multiplexing (SM), and therefore, allowing a more efficient offsets calculation, gaining an increase in spectral efficiency and an enhanced transmission mode recommendation for the scheduler to be used in the DL.

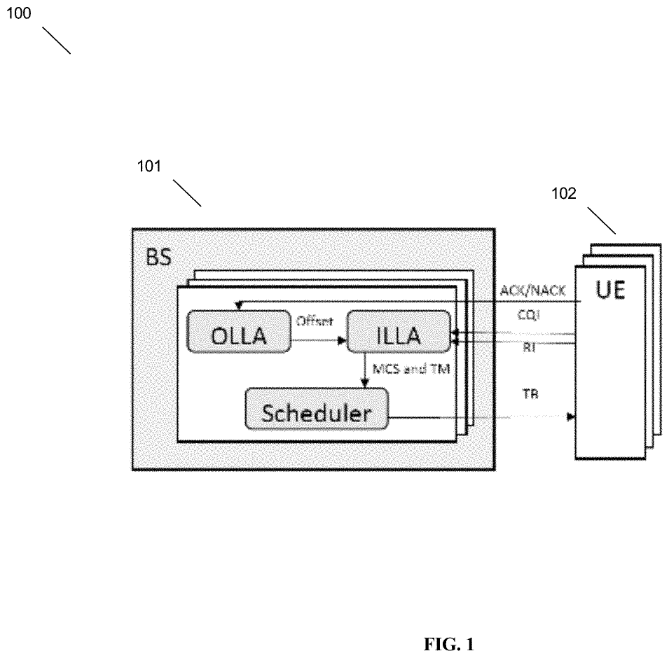

FIG. 1 is a schematic diagram of a base station scheduler, in accordance with some embodiments. Diagram 100 shows a base station 101 and a UE 102, where the base station shows multiple instances of an OLLA, an ILLA, and a scheduler in communication with UE 102.

As mentioned, OLLA calculates the offsets to be fed to the ILLA based on the HARQ reports, however, it doesn't take into consideration the MIMO method used for the DL transmission and therefore, the ILLA's calculated MCS will not be accurate, resulting in loss of spectral efficiency and reliability.

The present disclosure provides a method that can be implemented on a base station having a scheduler as shown.

Our solution comprises of dividing the OLLA into the two different transmissions modes, Upon an HARQ ACK/NACK for a TD transmission, OLLA will modify offset_{TD} and upon a HARQ for SM transmission, OLLA will modify the offset_{SM}, as follows,

OLLA calculates the MCS offset based on the ACK/NACK and the number of code words that were sent in the DL, in some embodiments.

Offsets are calculated separately for each TM and in the case of SM and transmission of two codewords, offsets are also calculated separately for each code word sent.

```
if (nCodewords==1)
    if UE_ACK
      offset_TD = min(max_offset ,max(min_offset ,offset_TD −
      offsetStepDown))
    else
      offset_TD = min(max_offset ,max(min_offset ,offset_TD +
      offsetStepUp))
    end
else if UE_ACK[CW]
      offset_SM[CW] = min(max_offset ,max(min_offset ,
      offset_SM[CW]− offsetStepDown))
    else
      offset_SM[CW] = min(max_offset ,max(min_offset
      offset_SM[CW] + offsetStepUp))
    end
  end
```

Where,

NCodewords, is the number of codewords HARQ feedback received on.

OffsetStepDown and offsetStepUp are the negative/positive offset step sizes taken for an NACK/ACK event, following the next formula,

$$offsetStepDown = ( \frac{TargetBLER}{100 - targetBLER} ) * offsetStepUp$$

ILLA receives the OLLA offsets and correspondently updates the relevant MCS as follows,
If the UE's reported RI 1, ILLA shall calculate MCS_{TD}=MCS_{TD}(CQI)−offset_{TD}
And TD will be reported as the preferred MIMO mode to the scheduler.
If the UE's reported RI 2, ILLA shall calculate

MCS_{SM}[CW]=MCS_{SM}[CW](CQI)−offset_{SM}[CW]

MCS_{TD}=MCS_{TD(CQI)}−offset_{TD}
1.1. ILLA shall calculate the spectral efficiency of using MCS_{TD}, MCS_{SM}[CW] (when using the two codewords),
   ILLA shall suggest the scheduler the most efficient TM from the two.

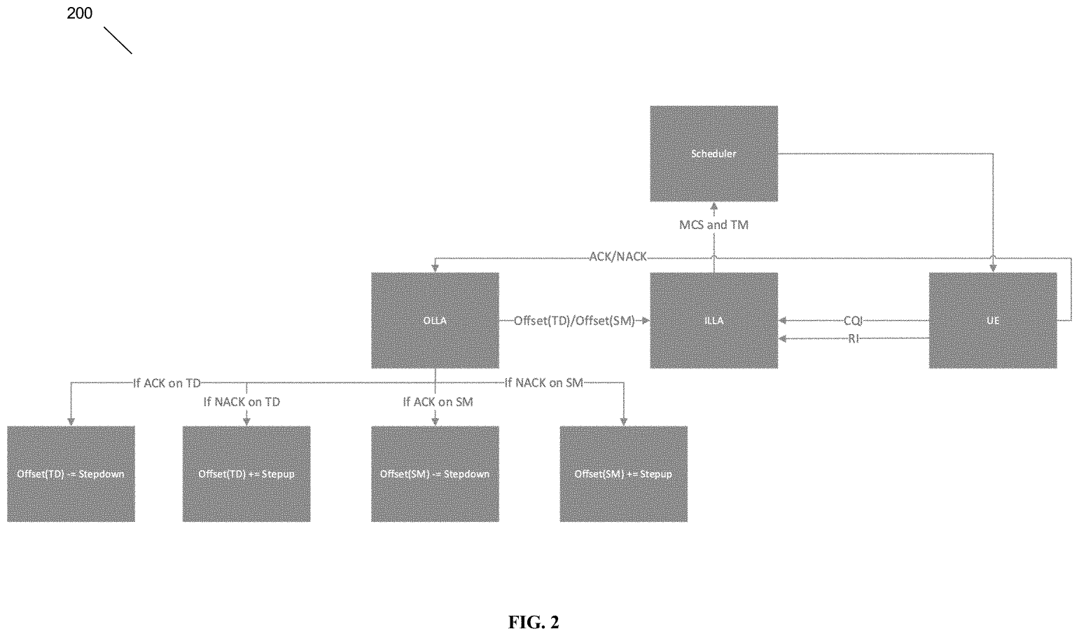

FIG. 2 is a flowchart 200, in accordance with some embodiments, that is substantially described in the preceding paragraphs.

In some embodiments, the information about the selected transmission mode (TM) can be used in any radio access technology utilizing OLLA. For example, 5G utilizes OLLA and the OLLA algorithm that is used in, for example, 5G can be enhanced by providing to the scheduler the transmission mode information, regarding whether the TM is TD or SM, and enabling a separate processing path per UE and per transmission mode. In some embodiments, other parameters beyond MCS, such as numerology in 5G, could be adjusted based on link adaptation. In some embodiments, an OLLA algorithm can be enhanced by taking separate paths depending on TM.

In some embodiments, the selected TM is reported by the UE; in other embodiments, the selected TM is identified at the base station by characteristics of the link or by receiving one or more relevant requests or data packets from the UE. In some embodiments, base stations with different baseband functional splits could be supported. In some embodiments, a plurality of UEs could be supported, each with a different TM. In some embodiments, a plurality of UEs and RATs and/or TMs could be supported at once. In some embodiments, the base station may be aware when a change in TM is imminent and may make decisions based on the predicted TM knowledge.

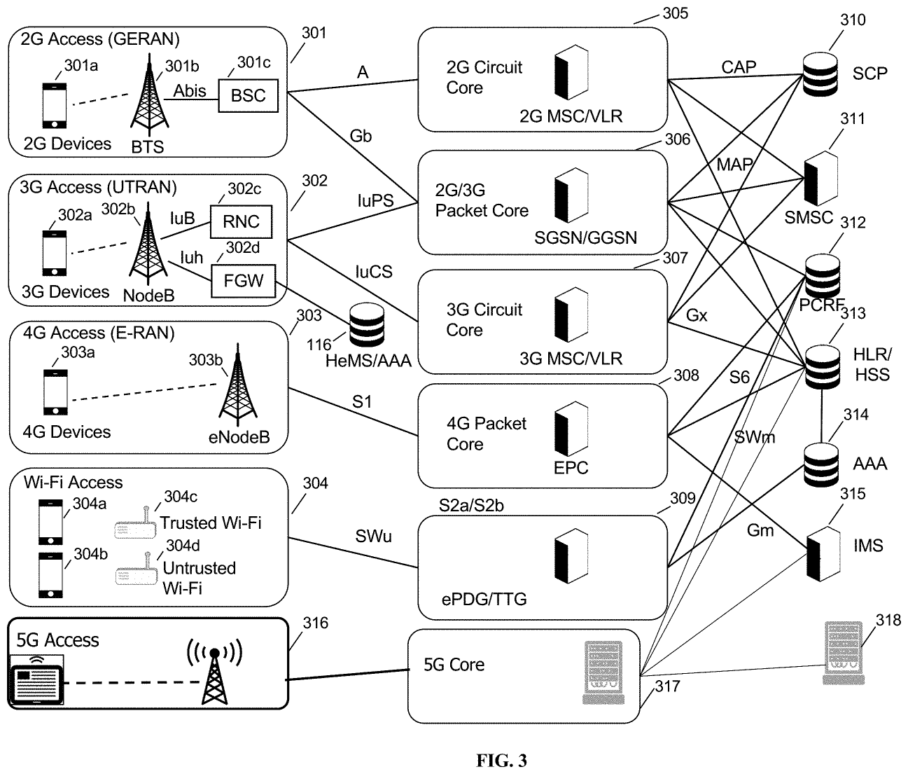

FIG. 3 is a schematic network architecture diagram for 3G and other-G prior art networks. The diagram shows a plurality of “Gs,” including 2G, 3G, 4G, 5G and Wi-Fi. 2G is represented by GERAN 301, which includes a 2G device 301a, BTS 301b, and BSC 301c. 3G is represented by UTRAN 302, which includes a 3G UE 302a, nodeB 302b, RNC 302c, and femto gateway (FGW, which in 3GPP namespace is also known as a Home nodeB Gateway or HNBGW) 302d. 4G is represented by EUTRAN or E-RAN 303, which includes an LTE UE 303a and LTE eNodeB 303b. Wi-Fi is represented by Wi-Fi access network 304, which includes a trusted Wi-Fi access point 304c and an untrusted Wi-Fi access point 304d. The Wi-Fi devices 304a and 304b may access either AP 304c or 304d. In the current network architecture, each “G” has a core network. 2G circuit core network 305 includes a 2G MSC/VLR; 2G/3G packet core network 306 includes an SGSN/GGSN (for EDGE or UMTS packet traffic); 3G circuit core 307 includes a 3G MSC/VLR; 4G circuit core 308 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 330, the SMSC 331, PCRF 332, HLR/HSS 333, Authentication, Authorization, and Accounting server (AAA) 334, and IP Multimedia Subsystem (IMS) 335. An HeMS/AAA 336 is present in some cases for use by the 3G UTRAN. The diagram is used to indicate schematically the basic functions of each network as known to one of skill in the art, and is not intended to be exhaustive. For example, 5G core 317 is shown using a single interface to 5G access 316, although in some cases 5G access can be supported using dual connectivity or via a non-standalone deployment architecture.

Noteworthy is that the RANs 301, 302, 303, 304 and 336 rely on specialized core networks 305, 306, 307, 308, 309, 337 but share essential management databases 330, 331, 332, 333, 334, 335, 338. More specifically, for the 2G GERAN, a BSC 301c is required for Abis compatibility with BTS 301b, while for the 3G UTRAN, an RNC 302c is required for Iub compatibility and an FGW 302d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. The present invention is also applicable for 5G networks since the same or equivalent functions are available in 5G. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

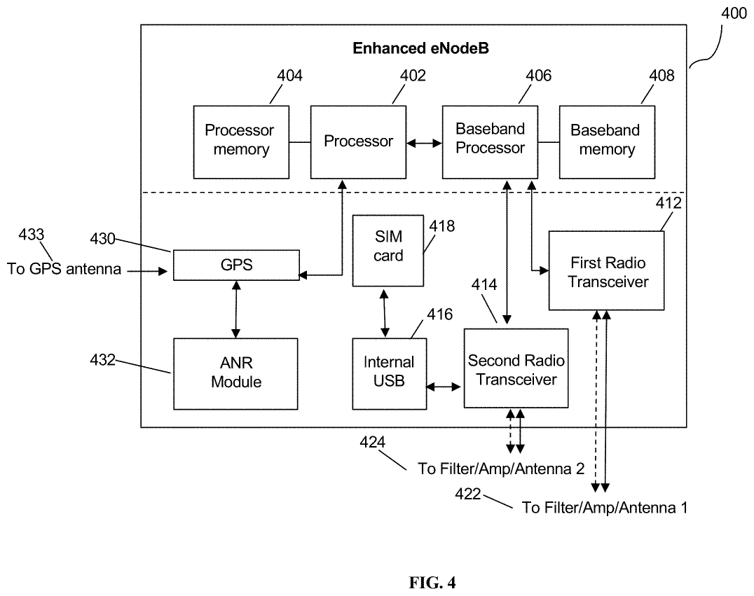

FIG. 4 is an enhanced eNodeB for performing the methods described herein, in accordance with some embodiments. eNodeB 400 may include processor 402, processor memory 404 in communication with the processor, baseband processor 406, and baseband processor memory 408 in communication with the baseband processor. Mesh network node 400 may also include first radio transceiver 412 and second radio transceiver 414, internal universal serial bus (USB) port 416, and subscriber information module card (SIM card) 418 coupled to USB port 416. In some embodiments, the second radio transceiver 414 itself may be coupled to USB port 416, and communications from the baseband processor may be passed through USB port 416. The second radio transceiver may be used for wirelessly backhauling eNodeB 400.

Processor 402 and baseband processor 406 are in communication with one another. Processor 402 may perform routing functions, and may determine if/when a switch in network configuration is needed. Baseband processor 406 may generate and receive radio signals for both radio transceivers 412 and 414, based on instructions from processor 402. In some embodiments, processors 402 and 406 may be on the same physical logic board. In other embodiments, they may be on separate logic boards.

Processor 402 may identify the appropriate network configuration, and may perform routing of packets from one network interface to another accordingly. Processor 402 may use memory 404, in particular to store a routing table to be used for routing packets. Baseband processor 406 may perform operations to generate the radio frequency signals for transmission or retransmission by both transceivers 410 and 412. Baseband processor 406 may also perform operations to decode signals received by transceivers 412 and 414. Baseband processor 406 may use memory 408 to perform these tasks.

The first radio transceiver 412 may be a radio transceiver capable of providing LTE eNodeB functionality, and may be capable of higher power and multi-channel OFDMA. The second radio transceiver 414 may be a radio transceiver capable of providing LTE UE functionality. Both transceivers 412 and 414 may be capable of receiving and transmitting on one or more LTE bands. In some embodiments, either or both of transceivers 412 and 414 may be capable of providing both LTE eNodeB and LTE UE functionality. Transceiver 412 may be coupled to processor 402 via a Peripheral Component Interconnect-Express (PCI-E) bus, and/or via a daughtercard. As transceiver 414 is for providing LTE UE functionality, in effect emulating a user equipment, it may be connected via the same or different PCI-E bus, or by a USB bus, and may also be coupled to SIM card 418. First transceiver 412 may be coupled to first radio frequency (RF) chain (filter, amplifier, antenna) 422, and second transceiver 414 may be coupled to second RF chain (filter, amplifier, antenna) 424.

SIM card 418 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 400 is not an ordinary UE but instead is a special UE for providing backhaul to device 400.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 412 and 414, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 402 for reconfiguration.

A GPS module 430 may also be included, and may be in communication with a GPS antenna 432 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 432 may also be present and may run on processor 402 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow.

1. A method for enhancing downlink link adaptation (DLLA) for spectral efficiency maximization, comprising:
providing an outer loop link adaptation (OLLA) routine with a first path for a first transmission mode and a second path for a second transmission mode;
modifying, upon receiving a retransmit message for a first transmission with the first transmission mode, a first offset coefficient;
modifying, upon receiving a second retransmit message for a second transmission with the second transmission mode, a second offset coefficient; and
calculating a modulation and coding scheme (MCS) offset for the first transmission based on the first offset coefficient.

2. The method of claim 1, wherein the retransmit message is an HARQ ACK/NACK and the first transmission mode is a transmit diversity (TD) transmission mode and the first offset coefficient is an offset_{TD}.

3. The method of claim 1, wherein the second retransmit message is an HARQ ACK/NACK and the second transmission mode is a spatial multiplexing (SM) transmission mode and the second offset coefficient is an offset_{SM}.

4. The method of claim 1, further comprising calculating a modulation and coding scheme (MCS) offset based on an ACK/NACK and a number of code words that were sent.

5. The method of claim 1, wherein the OLLA routine is for a 4G LTE radio access technology or a 5G radio access technology.

6. The method of claim 1, wherein a transmission mode is reported by a user equipment (UE).

7. The method of claim 1, further comprising providing the MCS offset to an inner loop link adaptation (ILLA) routine.

8. The method of claim 1, further comprising calculating a second modulation and coding scheme (MCS) offset for the second transmission based on the second offset coefficient.

9. The method of claim 1, further comprising reporting a preferred transmission mode to a scheduler.

10. The method of claim 1, further comprising subtracting a specific stepdown quantity from the MCS offset if a NACK is received.

11. The method of claim 1, further comprising adding a specific step up quantity from the MCS offset if an ACK is received.
